(19) United States
(12) Patent Application Publication
(10) Pub. No.: US 2018/0058141 A1
(43) Pub. Date: Mar. 1, 2018

(54) DOOR PANEL FOR MOBILE GARAGE

(71) Applicant: RIZHAO J&J MANUFACTURING CO., LTD, RIZHAO (CN)

(72) Inventor: WEI ZHAO, Rizhao (CN)

(21) Appl. No.: 15/345,770

(22) Filed: Nov. 8, 2016

(30) Foreign Application Priority Data
Aug. 26, 2016 (CN) 201620955715.7

(51) Int. Cl. E06B 9/06; E06B 3/80; E04H 6/00

(52) U.S. Cl. CPC E06B 9/0692; E06B 2003/7044; E04H 6/005; E06B 3/80

(57) ABSTRACT

A door panel for a mobile garage includes a first webbing and a second webbing. A free end of the first webbing is detachably connected with a free end of the second webbing. By using the door panel provided by embodiments of the present invention, installing of the door panel can be implemented without dismantling and reassembling junctions of the frame of the mobile garage. The installing manner is simpler and easier to be understood comparing that of the prior door panel, and time and labor are significantly saved.

### CROSS-REFERENCE TO RELATED APPLICATIONS

The present application claims priority under 35 U.S.C. §119 from Chinese Patent Applications No. 201620955715.7, filed on Aug. 26, 2016, the entire contents of which are incorporated herein by reference for all purposes.

### TECHNICAL FIELD

Embodiments of the present invention relate to a cover, particularly to a door panel for a mobile garage.

### BACKGROUND

On the current market of prior door panels for mobile garages, one prior door panel has only one webbing, and both ends of the webbing are fixed to the same side of the door panel, so the door panel must be installed after dismantling of the frame of the mobile garage. Taking a peak top mobile garage as an example, as shown in FIG. 1, before the door panel is installed, the junctions used for connecting the head part 4 and the shoulder parts 5a and 5b of the peak top mobile garage need to be dismantled in advance, then the webbing is installed by bypassing the junctions, and at last the junctions are reassembled. It can be seen that the installing manner of the prior door panel needs a lot of human cooperation, which wastes too much time and labor and is too complicated.

### SUMMARY

In view of this, embodiments of the present invention provide a door panel for a mobile garage, the installing manner of which can avoid dismantling and reassembling of the frame of the mobile garage.

According to embodiments of the present invention, a door panel for a mobile garage is provided. The door panel includes a first webbing and a second webbing. A free end of the first webbing is detachably connected with a free end of the second webbing.

When the door panel needs to be installed onto a mobile garage, the free ends of the two webbings need to be separated in advance, then the first webbing and the second webbing are installed by bypassing shoulder parts respectively, and at last the free ends of the two webbings are reconnected mutually. By using the door panel provided by embodiments of the present invention, installing of the door panel can be implemented without dismantling and reassembling junctions of the frame of the mobile garage. The installing manner is simpler and easier to be understood comparing that of the prior door panel, and time and labor are significantly saved.

### BRIEF DESCRIPTION OF DRAWINGS

These and/or other aspects will become apparent and more readily appreciated from the following description of the embodiments, taken in conjunction with the accompanying drawings in which:

FIG. 1 is a schematic view illustrating a structure of a peak top mobile garage in the prior art;

FIG. 2 is a schematic view illustrating a structure of a door panel of a mobile garage according to an embodiment of the present invention; and

FIG. 3 is a schematic view illustrating a partial structure of a mobile garage with a door panel according to an embodiment of the present invention.

### DETAILED DESCRIPTION

Hereinafter, embodiments of the present invention will be described in detail with reference to the accompanying drawings. The technical solutions will be described clearly and completely. Apparently, the embodiments described are only examples of the present invention. According to the embodiments of the present invention, without creative efforts all embodiments obtained by the ordinary in the art, belongs to the protection scope of the present invention.

According to an embodiment of the present invention, a door panel for a mobile garage is provided. The door panel includes a first webbing and a second webbing, and each webbing has a free end and a fixed end. The free ends of the two webbings are mutually connected detachably. The fixed ends of the two webbings are fixed to the same side of the door panel. The connecting manner mentioned above can avoid dismantling and reassembling of the frame of the mobile garage.

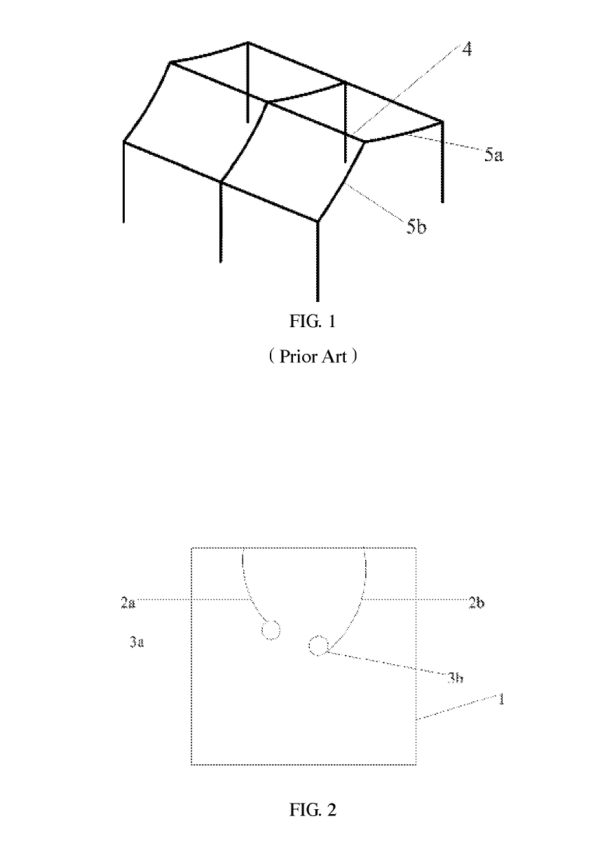

FIG. 2 is a schematic view illustrating a structure of a door panel of a mobile garage according to an embodiment of the present invention. As shown in FIG. 2, the door panel 1 includes a first webbing 2a, a second webbing 2b and a fastener. The fastener includes a female part 3a and a male part 3b. A fixed end of the first webbing 2a is fixed to an end of a side of the door panel 1, and a fixed end of the second webbing 2b is fixed to the other end of the same side of the door panel 1. A free end of the first webbing 2a is connected with the female part 3a, and a free end of the second webbing 2b is connected with the male part 3b.

In an embodiment of the present invention, the free end of the first webbing 2a may be sewn with the female part 3a, and the free end of the second webbing 2b may be sewn with the male part 3b.

In an embodiment of the present invention, the fastener may be made of stainless steel.

In an embodiment of the present invention, the fastener may be a snap button.

In an embodiment of the present invention, the fastener may be a veltro.

In an embodiment of the present invention, the two webbings may be weaved by polymer materials.

In an embodiment of the present invention, the two webbings may be weaved by metal wires.

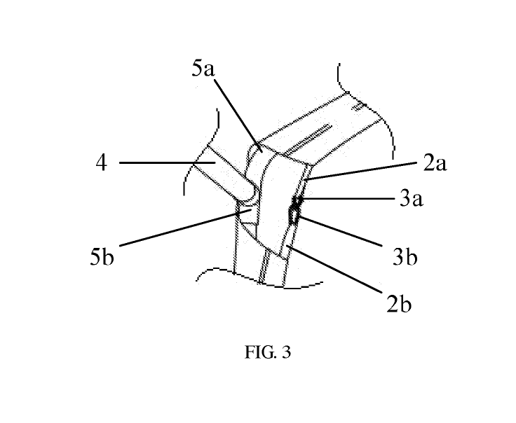

When the door panel 1 needs to be installed, the female part 3a and the male part 3b need to be separated in advance, then the first webbing 2a and the second webbing 2b are installed by respectively bypassing the shoulder parts 5a and 5b connected with the head part 4 (referring to FIG. 3 which is a schematic view illustrating a partial structure of a mobile garage with a door panel according to an embodiment of the present invention), and at last the female part 3a and male part 3b are reconnected.

It can be understood by those skilled in the art that the shape of the mobile garage, the number and material of the webbings, the shape and material of the fastener and the connecting manner between the webbings and the fastener cannot be used to limit the protection scope of the present invention.

By using the door panel provided by embodiments of the present invention, dismantling and reassembling of the frame of the mobile garage during the installing process can be avoided, time and labor can be significantly saved since the installing process can be completed by only one person, and the function of the door panel isn't affected.

The embodiments described above are preferred only and not for purpose of limitation. It will be understood that various changes in form and their equivalents without departing from the spirit and principle should be within the protection scope of the present invention.

What is claimed is:

1. A door panel for a mobile garage, comprising:
a first webbing and a second webbing;
wherein a free end of the first webbing is detachably connected with a free end of the second webbing.

2. The door panel of claim 1, further comprising:
a fastener, comprising a female part and a male part;
wherein the free end of the first webbing is connected with the female part of the fastener, and the free end of the second webbing is connected with the male part of the fastener.

3. The door panel of claim 2, wherein the fastener is made of stainless steel.

4. The door panel of claim 2, wherein the fastener is a snap button.

5. The door panel of claim 2, wherein the fastener is a veltro.

6. The door panel of claim 1, wherein the first webbing and the second webbing are weaved by polymer materials.

7. The door panel of claim 5, wherein the first webbing and the second webbing are weaved by metal wires.

8. The door panel of claim 2, wherein the free end of the first webbing is sewn with the female part.

9. The door panel of claim 2, wherein the free end of the second webbing is sewn with the female part.

10. The door panel of claim 1, wherein a fixed end of the first webbing is fixed to an end of a side of the door panel, and a fixed end of the second webbing is fixed to the other end of the same side of the door panel.
